(19) United States
(12) Patent Application Publication
(10) Pub. No.: US 2016/0148175 A1
(43) Pub. Date: May 26, 2016

(54) SYSTEMS AND METHODS OF USING MULTIPLE COMMUNICATION CHANNELS TO TRANSMIT DATA IN NETWORKS OF SEPARATE COMPUTING SYSTEMS IN PREPARATION FOR THE PROCESSING OF A SUBSEQUENT COMPUTING TASK IN ONE OF THE NETWORKS

(71) Applicant: Visa International Service Association, San Francisco, CA (US)

(72) Inventor: Joseph Bjorn Ovick, San Francisco, CA (US)

(21) Appl. No.: 14/950,992

(22) Filed: Nov. 24, 2015

Related U.S. Application Data
(60) Provisional application No. 62/084,513, filed on Nov. 25, 2014.

(51) Int. Cl. G06Q 20/10; G06Q 20/40

(52) U.S. Cl. CPC G06Q 20/10; G06Q 20/405

(57) ABSTRACT

A computing apparatus having: a processing system connected in a first network of computers having a predetermined communication protocol for communication among at least the processing systems, terminals, and resource controllers in the first network; a portal connected to a second network and providing an application programming interface for communication with the terminals independent from the predetermined communication protocol; and a data store coupled with the processing system and the portal. The portal receives, via the application programming interface, context data via the second network; and the processing system receives, transaction data transmitted in the first network according to the predetermined communication protocol. Via the data store, the computing apparatus correlates the context data with the transaction data to process an add-on task, in addition to the tasks associated with the transaction data in the first network.

### RELATED APPLICATIONS

The present application claims priority to the Prov. U.S. Pat. App. Ser. No. 62/084,513, filed Nov. 25, 2014, the entire disclosure of which application is hereby incorporated herein by reference.

The present application relates to U.S. Pat. App. Pub. No. 2013/0091000, entitled “Systems and Methods to Provide Discount at Point of Sales Terminals,” U.S. Pat. App. Pub. No. 2013/0246150, entitled “Systems and Methods to Apply the Benefit of Offers via a Transaction Handler”, U.S. Pat. App. Pub. No. 2013/0124287, entitled “Systems and Methods to Provide Discount at Point of Sales Terminals”, U.S. Pat. App. Pub. No. 2013/0268333, entitled “Systems and Methods to Process Transactions and Offers via a Gateway”, and U.S. Pat. App. Pub. No. 2011/0125565, entitled “Systems and Methods for Multi-Channel Offer Redemption,” U.S. Pat. No. 8,880,431, entitled “Systems and Methods to Generate a Receipt for a Transaction”, U.S. Pat. App. Pub. No. 2014/0129308, entitled “Systems and Methods to Provide Offer Benefits based on Issuer Identity,” U.S. Pat. App. Pub. No. 2014/0129314, entitled “Systems and Methods to Facilitate the Redemption of Loyalty Currency”, U.S. Pat. App. Pub. No. 2013/0024307, entitled “Systems and Methods to Communicate with Transaction Terminals”, the entire disclosures of which applications are hereby incorporated herein by reference.

### FIELD OF THE TECHNOLOGY

At least some embodiments disclosed in the present application relate to the coordination of a plurality of separate computer systems connected via computer networks to set up the processing of a predetermined task.

### BACKGROUND

In a system having multiple computer systems connected via one or more computer networks, resources for processing a task may reside in different computer systems. The use of a predetermined communication protocol allows the computer systems to communicate with each other in a predetermined way to utilize the resources that may be distributed among the computer systems for the processing of the task. Improvements to the communication protocol can improve the performance of the system as a whole and/or improve the functionalities of the system as a whole. In some instances, improvements to the communication protocol can improve the performance of some of the individual computer systems and/or improve the functionalities of the individual computer systems.

For example, a typical electronic payment processing network has a transaction handler interconnecting a plurality of acquirer processors and a plurality of issuer processors according to an electronic communication standard. The transaction handler is generally a special purpose computer system that is substantially independent from other computer systems in the network, such as issuer processors and the acquirer processors, which are special purpose computer systems configured to control accounts from which payments are made and special purpose computer systems configured to control accounts to which the payments are made, respectively.

A typical electronic payment processing network has the capability to process certain transactions, such as credit card or debit card transactions, but may not have the capability process other transactions, such as add-on transactions (e.g., loyalty reward, benefit redemption) coupled with regular transactions.

Some recent developments provided improved electronic payment processing networks that have the improved capability to process certain add-on transactions coupled with conventional electronic payment transactions, such as those disclosed in U.S. Pat. App. Pub. No. 2014/0222533, entitled “Systems and Methods to Use Transaction Authorization Communications to Process Individualized Offers,” U.S. Pat. App. Pub. No. 2013/0282461, entitled “Systems and Methods to Use Transaction Authorization Communications to Process Offers,” U.S. Pat. App. Pub. No. 2013/0246150, entitled “Systems and Methods to Apply the Benefit of Offers via a Transaction Handler,” U.S. Pat. App. Pub. No. 2013/0091000, entitled “Systems and Methods to Provide Discount at Point of Sales Terminals,” U.S. Pat. App. Pub. No. 2013/0124287, entitled “Systems and Methods to Provide Discount at Point of Sales Terminals,” and U.S. Pat. App. Pub. No. 2011/0125565, entitled “Systems and Methods for Multi-Channel Offer Redemption,” the disclosures of which applications are hereby incorporated herein by reference.

There are challenges in implementing the additional capabilities with minimum impact to the performance of the core functionalities of the electronic payment processing network.

The disclosures of the above discussed patent documents are hereby incorporated herein by reference.

### BRIEF DESCRIPTION OF THE DRAWINGS

The embodiments are illustrated by way of example and not limitation in the figures of the accompanying drawings in which like references indicate similar elements.

FIG. 1 shows a system configured to use different networks to communicate correlated data for the processing of an add-on task according to one embodiment.

FIG. 2 shows a method configured to use different networks to communicate correlated data for the processing of an add-on task according to one embodiment.

FIG. 3 shows a system to collect purchase details and apply offer benefits according to one embodiment.

FIG. 4 shows a method to collect purchase details and apply offer benefits according to one embodiment.

FIG. 5 illustrates a system to provide services based on transaction data according to one embodiment.

FIG. 6 shows a system to provide information based on transaction data according to one embodiment.

FIG. 7 illustrates a transaction terminal according to one embodiment.

FIG. 8 illustrates an account identifying device according to one embodiment.

FIG. 9 illustrates a data processing system according to one embodiment.

### DETAILED DESCRIPTION

In one embodiment, multiple communication channels are used to transmit data in networks of separate computing systems in preparation for the processing of a subsequent add-on computing task in connection with the processing of a computing task in a primary network of the networks. Thus, the impact of the additional data communicated for the add-on task on the performance of the primary network is minimized.

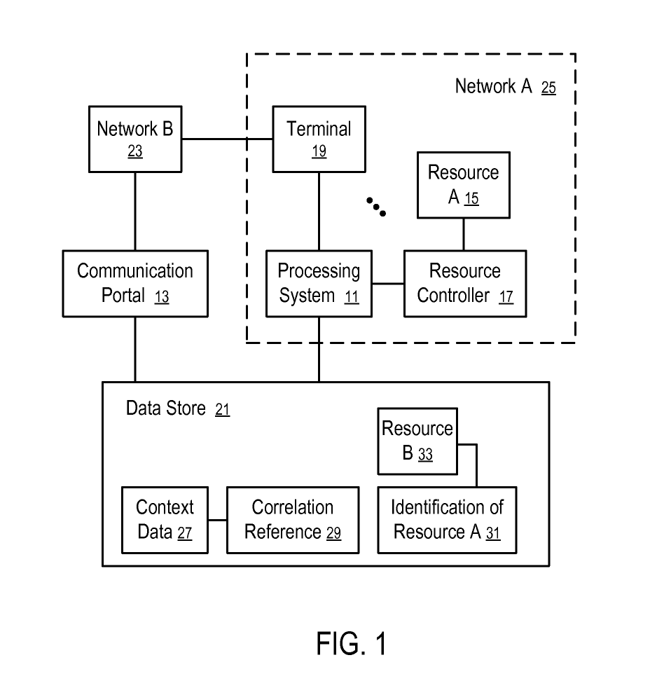

FIG. 1 shows a system configured to use different networks to communicate correlated data for the processing of an add-on task according to one embodiment.

In FIG. 1, a computer network A (25) includes terminals (e.g., 19), a processing system (11), and resource controllers (e.g., 17).

In FIG. 1, the resource controller (17) controls the resource (15). A predetermined communication protocol is used in the network A (25) to communicate messages of predetermined types regarding operations initiated on terminals (e.g., 19) using resources (e.g., 15) controlled by the resource controllers (e.g., 17). The processing system (11) is configured in the network A (25) to facilitate the communications among various computers, including the terminals (e.g., 19) and the resource controllers (e.g., 17) in the network.

In FIG. 1, a communication portal (13) provides the terminal (19) with a separate communication channel through network B (23) for communicating with the processing system (11). For example, the communication portal (13) of one embodiment provides an application programming interface to communicate with the terminal (19), e.g., via Internet.

In FIG. 1, the communication portal (13) is configured to receive context data (27) from the terminal (19) via the network B (23), and stores in the data store (21) the context data (27) in association with a correlation reference (29). The correlation reference (29) allows the processing system (11) to correlate the context data (27) with transaction data transmitted by the terminal (19) in the network A (25) using the predetermined communication protocol in the network A (25).

In FIG. 1, the data store (21) stores the data associating the identification (31) of the resource A (15) with a separate resource B (33). After the transaction data identifying the resource A (15) is transmitted by the terminal (19) in the network A (25) using the predetermined communication protocol, the processing system (11) identifies the resource B (33) based on the data in the data store (21) associating the identification (31) of the resource A (15) with the resource B (33). Further, the processing system (11) uses the correlation reference (29) to identify the context data (27) of the transaction data. Using the context data (27), transmitted via the network B (23), the processing system (11) performs a predetermined add-on task based on the resource B (33), in addition to predetermined tasks that are pre-associated with the transaction data communicated in the network A (25) using the predetermined communication protocol for the network A (25). The predetermined tasks pre-associated with the transaction data communicated in the network A (25) is performed regardless of the availability and/or applicability of the context data (27) and/or the resource B (33). The configuration illustrated in FIG. 1 reduces the performance impact by the add-on task on the network A (25) in processing the predetermined tasks associated with the transaction data communicated in the network A (25) and other tasks in the network A (25).

In one embodiment, the terminal (19) is configured to generate a correlation reference (29) that is transmitted with the context data (27) via the network B (23) to the communication portal (13). The terminal (19) embeds the correlation reference (29) in the transaction data communicated in the network A (25) in accordance with the predetermined communication protocol in the network A (25). Thus, based on matching the correlation reference (29) transmitted with the context data (27) and the correlation reference (29) embedded in the transaction data, the processing system (11) correlates the context data (27) and the transaction data.

In one embodiment, the correlation reference (29) is generated from the transaction data. For example, a hash function can be applied to the transaction data, or a predetermined portion of the transaction data, to generate the correlation reference (29) independently by the terminal (19) and by the processing system (11). Thus, the terminal (19) does not have to explicitly provide the correlation reference (29) in the transaction data. Upon receiving the transaction data, the processing system (11) may apply the hash function to the transaction data, or a predetermined portion of the transaction data, to determine the correlation reference (29) of the transaction data.

Alternatively, the correlation reference (29) may be generated from the context data (27) (e.g., using a hash function) and provided in a field of the transaction data permitted by the predetermined communication protocol in the network A (25). Thus, the correlation reference (29) does not have to be explicitly transmitted with the context data (27) via the network B (23).

In one embodiment, the correlation reference (29) includes a random number, or a pseudo-random number, generated by the terminal (19).

In some embodiments, the correlation reference (29) is one or more selected fields in the transaction data that are transmitted according to the predetermined communication protocol in the network A (25). A time stamp and a predetermined time gap between the arrival times of context data and the transaction data can be used to resolve ambiguities, since the context data and the transaction data are transmitted substantially concurrently and/or in parallel in the network B and the network A. In one embodiment, the correlation reference (29) is an encrypted version of the one or more selected fields (e.g., encrypted using a public key of the portal (13), encrypted using a private key of the terminal (19), or encrypted using a secret shared between the terminal (19) and the portal (13)).

FIG. 1 illustrates one terminal (19). However, a typical network A (25) includes multiple terminals (e.g., 19) disposed in different locations. At least some of the terminals are configured to provide context data (27) in a way as illustrated in in connection with the terminal (19) shown in FIG. 1.

FIG. 1 illustrates one resource controller (17). However, a typical network A (25) includes multiple resource controllers (e.g., 17) connected to the processing system (11), where each of the resource controllers (e.g., 17) controls one or more resources (15) that may be identified by the transaction data communicated by the terminal (19) according to the predetermined protocol of the network A (25) to perform operations using the identified resource (e.g., 15).

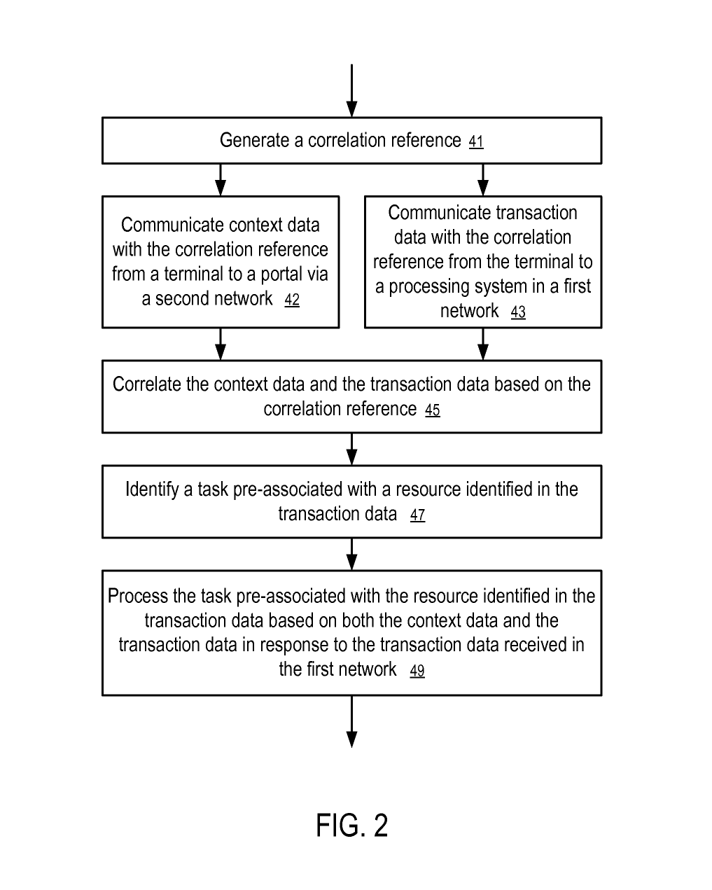

FIG. 2 shows a method configured to use different networks to communicate correlated data for the processing of an add-on task according to one embodiment. For example, the method of FIG. 2 can be implemented in a system illustrated in FIG. 1.

In FIG. 2, a terminal (19) generates (41) a correlation reference (29) and communicates (42) context data (27) with the correlation reference (29) to a portal (13) via a second network (23), while communicating (43) transaction data with the correlation reference (29) to a processing system (11) in a first network (25).

In FIG. 2, the processing system correlates (45) the context data (27) and the transaction data based least in part on the correlation reference (29), identifies (47) a task pre-associated with a resource (15) identified in the transaction data, and processes (49) the task pre-associated with the resource (15) identified in the transaction data based on both the context data (27) and the transaction data, in response to the transaction data received in the first network.

In FIG. 2, the task pre-associated with the resource (15) is performed based on a separate resource (33) associated in the data store (21) with the identification (31) of the resource (15) identified in the transaction data. The task pre-associated with the resource (15) is an add-on task, performed in addition to the predetermined tasks required by the transaction data in the network A (25).

The techniques discussed above in connection with FIGS. 1-2 can be used, for example, in the processing the benefit of an offer in connection with a payment transaction in an electronic payment processing network.

For example, in embodiment, the network A (25) is an electronic payment processing network that includes a transaction terminal as the terminal (19) in FIG. 1, a transaction handler (11) (or a payment processor) as the processing system (11) in FIG. 1, an issuer processor as the resource controller (17) in FIG. 1, a payment account as the resource A (15) in FIG. 1. A data warehouse as the data store (21) in FIG. 1 is configured to store item-level purchase data as the context data (27) in FIG. 1, and an offer as the resource B (33) in FIG. 1. The item-level purchase data identifies the specific items purchased by the user via the payment transaction initiated at the transaction terminal; and the transaction handler processes the offer benefit redemption based at least in part on the item-level purchase data provided as the context data (27).

In one embodiment, a computing apparatus is configured on an electronic payment processing network to process, in connection with payment processing on the network, offers that are dependent on item-level purchase details. Item-level purchase details are obtained from the Point of Sales terminal via an application programming interface over a separate network, e.g., Internet, in parallel with an authorization request transmitted in the electronic payment processing network for a payment transaction in a payment account. The parallel communications of the purchase details and the authorization are correlated with each other to identify the applicability of an item-level offer that is pre-associated with the payment account. If the offer is applicable, the benefit of the offer is provided to the payment transaction during the authorization processing of the payment transaction.

One embodiment disclosed herein includes systems and methods configured on an electronic payment processing network to process, in connection with payment processing on the network, offers that are dependent on item-level purchase details.

For example, the redemption of an offer of one embodiment requires the purchase of a predetermined item. The item may be identified at a stock-keeping unit (SKU) level. For example, the item may be identified via a stock-keeping unit (SKU), a Universal Product Code (UPC), or other identifiers that uniquely identify a set of identical products (or services).

In one embodiment, the offer is stored in association with a payment account in a data warehouse of a computing device configured on an electronic payment processing network, such as a transaction handler, an issuer processor, etc. Thus, the benefit of the offer can be provided to a payment transaction during the authorization of the payment transaction if the purchase made via the payment transaction satisfies the redemption requirements of the offer, such as the purchase of the predetermined item.

For example, a gateway can be used to receive an authorization request for a payment transaction in a way as discussed in U.S. Pat. App. Pub. No. 2013/0268333, the disclosure of which application is hereby incorporated herein by reference. The authorization request received via the gateway may include the item level purchase details to allow the determination that the purchase includes the predetermined item for the redemption of the offer. In response, the gateway and/or the transaction terminal (105) may adjust the transaction amount of the payment transaction to provide the benefit of the offer.

For example, the authorization response from the gateway may include the identification of the offer and/or the predetermined item to cause the transaction terminal to adjust the purchase price at the transaction terminal.

For example, the gateway may adjust the transaction amount of the payment transaction to generate the authorization requests to the issuer processor for the payment transaction and separately generate the authorization request to the sponsor processor for the authorization of the benefit of the offer.

For example, the authorization communication between the gateway and the transaction terminal (105) bypasses the acquirer processor (147) configured on the electronic payment processing network to control the merchant account (148) of the merchant involved in the payment transaction; and the transaction is pushed to the acquirer processor (147) after the authorization of the transaction (e.g., during the settlement of the payment transaction), as discussed in U.S. Pat. App. Pub. No. 2013/0268333.

Alternatively, the communication between the gateway and the transaction terminal does not involve the authorization of the payment transaction. Instead, the the communication between the gateway and the transaction terminal determines the applicability of the offer. In such embodiments, the offer communication between the transaction terminal and the portal may include the transaction terminal providing the purchase details to the portal, which allows the portal to determine whether the offer is applicable to the associated payment and if so, the portal providing the offer information identifying the applicable offer and/or the predetermined item that is included in the purchase details, which allows the transaction terminal to determine a modified purchase price to generate an authorization request for a payment in accordance with the modified purchase price.

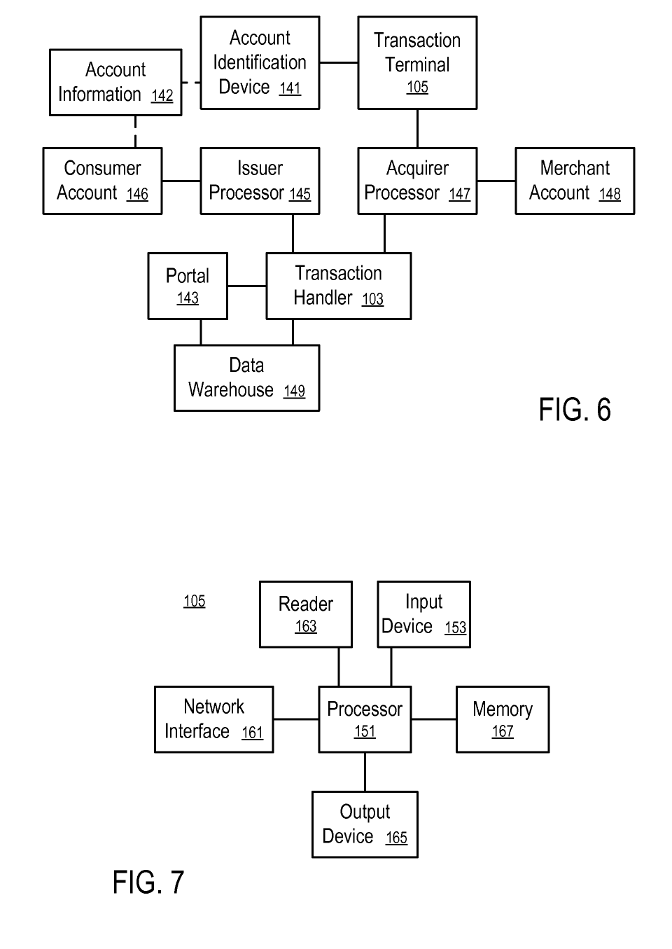

Using the techniques of FIGS. 1-2, the transaction terminal of one embodiment is configured to communicate with the portal (13) over a separate network (e.g., the Internet) using an application programming interface to provide the purchase details as the context data (27) and communicate on the electronic payment processing network, which may include the acquirer processor (147), the transaction handler (103), and the issuer processor (145) illustrated in FIG. 6, for the authorization of the payment transaction. The portal (13) is coupled with a computing device on the electronic payment processing network, such as the acquirer processor (147), the transaction handler (103), or the issuer processor (145), to determine applicability of the offer based on correlating the authorization request for the transaction and the purchase details provided separately of the internet. If the offer is determined to be applicable, the computing device on the electronic payment processing network, such as the acquirer processor (147), the transaction handler (103), or the issuer processor (145), adjust the payment transaction to provide the benefit of the offer (186).

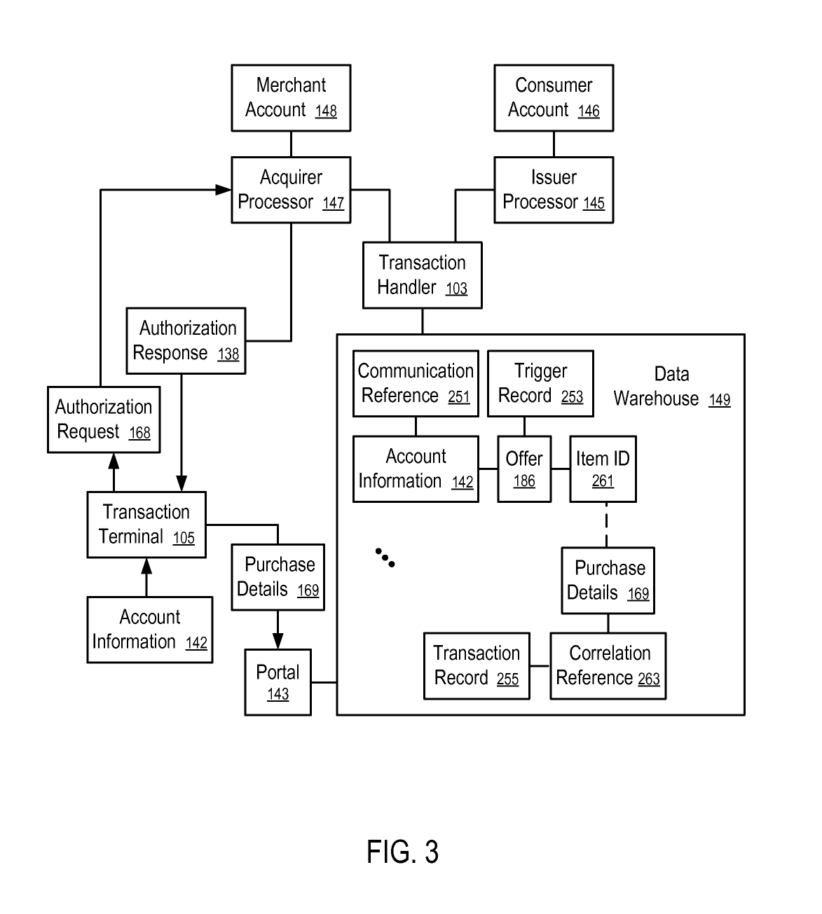

FIG. 3 shows a system to collect purchase details and apply offer benefits according to one embodiment.

In FIG. 3, the transaction terminal (105) is connected to both the electronic payment processing network interconnected by the transaction handler (103) (e.g., as illustrated in FIG. 6), and the internet via which the portal (143) provides an application programming interface to receive purchase details (169).

During a checkout process in the transaction terminal (105), the transaction terminal (105) determines the items purchased by the user and compute a total price for the purchase. The transaction terminal (105) then accepts the account information (142) to initiate a payment in the consumer account (146) that is identified by the account information (142).

On the electronic payment processing network (e.g., as illustrated in FIG. 6), the transaction terminal (105) uses a standard communication protocol of the payment transaction processing to transmit the authorization request (168) and receive the authorization response (138).

Concurrently with the authorization communications (168, 138), the transaction terminal (105) provides the purchase details (169) to the portal (143) via the application programming interface of the portal (143).

In one embodiment, the purchase details (169) include the account information (142); and the portal (143) is configured to determine the offer (186) that is associated with the account information (142) in the data warehouse (149) and that requires the purchase of an item identified by the item ID (261) associated with the offer (186). The portal (143) determines that the transaction is applicable to the purchase based at least in part that the purchase details (169) include the item ID (261).

In one embodiment, the portal (143) is configured to provide a response to the transaction terminal (105) when the purchase details (169) include the item ID (261) required for the redemption of the offer (186). For example, in the response, the portal (143) is configured to identify the offer (186) and/or the item ID (261); and thus, if the payment transaction is modified in the electronic payment processing system, the transaction terminal (105) can check the modification against the offer (186).

In one embodiment, the portal (143) is configured to generate the trigger record (253) in response to a determination that the purchase is relevant to the offer (186) and thus cause the transaction handler (103) to monitor the transactions processed in the electronic payment processing network to detect the corresponding payment transaction.

In one embodiment, the transaction terminal (105) is configured to transmit the authorization request (168) to the electronic payment processing network in parallel with the transmitting of the purchase details (169) to the portal (143). Thus, the authorization request (168) may arrive at the transaction handler (103) earlier than the purchase details (169) in the data warehouse (149).

In one embodiment, in response to a determination that a payment transaction is made using the account information (142) that is associated with the offer (186) that may be applicable to the payment transaction, the transaction handler (103) is configured to determine identify purchase details (169) based on the correlation reference (263).

For example, in response to the authorization request (168), the transaction handler (103) generates a transaction record (255) for the payment transaction. The transaction record (255) can be correlated to the corresponding purchase details (169) received separately via the purchase details (169) based on correlation reference (263), which may include one or more of: a matching payment amount, matching transmission time-stamps within a predetermined time period from each other, the matching account information (142) transmitted with the authorization request (168) and the purchase details (169).

In one embodiment, to avoid transmitting the account information (142) over the internet to the portal (143), the transaction terminal (105) may use a correlation identifier. For example, the transaction terminal (105) may generate a random number as the correlation reference that is transmitted with the authorization request (168) and the purchase details (169). For example, the transaction terminal (105) may request the portal (143) to assign a reference number for paring the authorization request (168) and the purchase details (169), etc. For example, the transaction terminal (105) may generate a hash value from the authorization request (168) (or a portion of the authorization request (168)) as the correlation reference (263) transmitted in the purchase details (169). For example, the transaction terminal (105) may generate a hash value from the purchase details (169) as the correlation reference (263) provided in authorization request (168).

In one embodiment, after correlating the purchase details (169) with the transaction record (255) via the correlation reference (263), the transaction handler (103) and/or the portal (143) is configured to determine the applicability of the offer (186) based at least in part on whether the purchase details (169) include the item ID (261) required for the benefit of the offer (186).

In response to the determination that the offer (186) is applicable to the payment transaction corresponding to the authorization request (168), the transaction handler (103) is configured to adjust the transaction amount in the consumer account (146) in accordance with the offer benefit.

For example, if the offer (186) is sponsored by the merchant, the transaction handler (103) may adjust the transaction amount in a way as discussed in U.S. Pat. App. Pub. Nos. 2013/0124287 and 2013/0091000, the disclosures of which applications are hereby incorporated herein by reference.

For example, if the offer (186) is sponsored by a sponsor processor (649), the transaction handler (103) may adjust the transaction amount in the consumer account and request the authorization from the sponsor processor in a way as discussed in U.S. Pat. App. Pub. No. 2013/0246150, the disclosure of which application is hereby incorporated herein by reference.

In one embodiment, when the offer (186) is at least in part sponsored by the merchant, the transaction amount in the authorization response (138) is reduced from the transaction amount in the authorization request (168) by the amount of the benefit sponsored by the merchant.

In one embodiment, the transaction handler (103) is configured to provide in the authorization response (138) information about the offer (186) and/or the item ID (261) to indicate the provisioning of the offer benefit during the authorization of the payment transaction.

Alternatively or in combination, the portal (143) is configured to provide the identification information of the offer (186) and/or the item ID (261) to indicate the provisioning of the offer benefit during the authorization of the payment transaction.

In one embodiment, the portal (169) and the transaction handler (103) process the authorization request (168) and the purchase details (169) in parallel. When the transaction handler (103) determines that the authorization request (168) may require purchase details (169) to determine the applicability of the offer (186), the transaction handler (103) may wait for the purchase details (169) for up to a predetermined period of time. In some embodiments, if the communication of the purchase details (169) has not already initiated by the transaction terminal (105), the transaction handler (103) is configured to cause the portal (143) to initiate a request for the purchase details (169).

In one embodiment, the purchase details (169) received in the portal (143) do not indicate the account information (142). Thus, whether or not the offer (186) is applicable to the payment transaction is determined in response to the authorization request (168) that identifies the account information (142).

In one embodiment, the purchase details (169) received in the portal (143) indicates the account information (142). When the portal (143) determines that the payment transaction is applicable to the purchase, the portal (143) uses the correlation reference (263) to generate the trigger record (253) for the transaction handler (103) to detect the corresponding transaction in the electronic payment processing network. The trigger record (253) indicates the requirements that satisfy the correlation reference (263). Thus, the performance of the transaction handler (103) in processing the payment transaction is improved by creating the trigger record (253) in response to the purchase details (169) and thus eliminating the need for the transaction handler (103) to perform computations for detecting the transaction at a time prior to the purchase details (169) being received in the portal (143).

In one embodiment, the transaction terminal (105) is configured to communicate with the portal (143) to determine if the purchase details (169) is required in the data warehouse (149) (e.g., by providing an indication of the account information (142)). If the portal (143) determines that the account information (142) is associated with one or more offers (186) that may need the purchase details to determine their applicability, the transaction terminal (105) provides the purchase details (169) as a response. Thus, the communication resources are optimized for the transmission of purchase details (169).

In one embodiment, the portal (143) and the transaction handler (103) receive the purchase details (169) and the authorization request (168) in parallel, and provide a response to the purchase details (169) and the authorization response (138) in parallel. When the authorization response (138) approves the payment transaction requested by the authorization request (168), the response to the purchase details (169) includes the applicable offer (186) and/or the item ID (261) to allow the transaction terminal (105) to generate a receipt that identify the applied offer (186). In one embodiment, the receipt is provided in a way discussed in U.S. Pat. No. 8,880,431, the disclosure of which is hereby incorporated herein by reference. The transaction terminal (105) may mark the transaction record with offer details for reconciliation.

FIG. 3 illustrates an example of coupled with the portal (143) with the transaction handler (103) on the electronic payment processing network. Alternatively, the portal (143) can be coupled with other computing devices on the electronic payment processing network, such as the issuer processor (145) or the acquirer processor (147), to implement the offer redemption in a similar way.

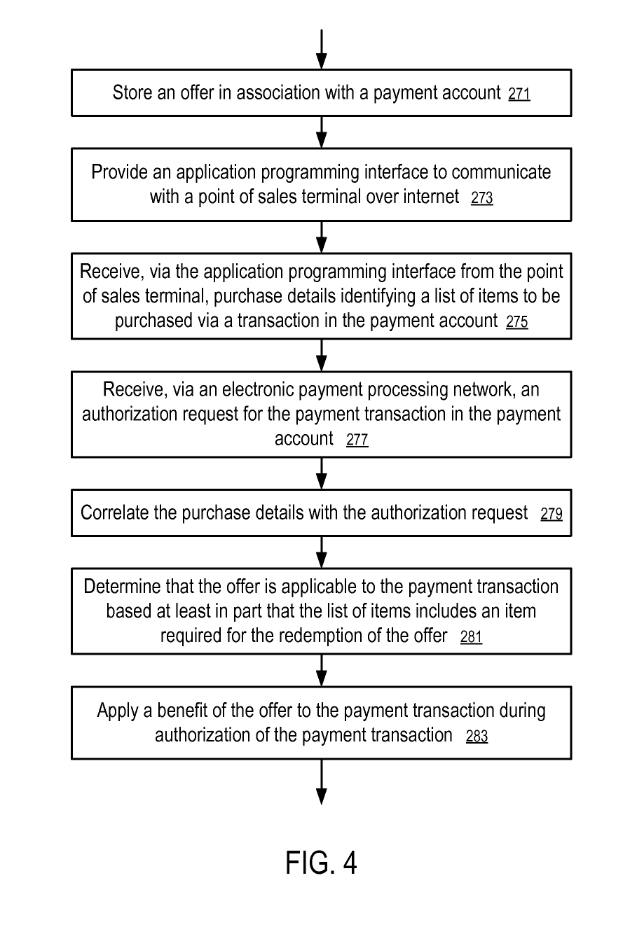

FIG. 4 shows a method to collect purchase details and apply offer benefits according to one embodiment. For example, the method of FIG. 4 can be implemented in a system illustrated in FIG. 3.

In FIG. 4, a computing device is configured to: store (271) an offer in association with a payment account; provide (273) an application programming interface to communicate with a point of sales terminal over internet; receive, (275) via the application programming interface from the point of sales terminal, purchase details identifying a list of items to be purchased via a transaction in the payment account; receive, (277) via an electronic payment processing network, an authorization request for the payment transaction in the payment account; correlate (279) the purchase details with the authorization request; determine (281) that the offer is applicable to the payment transaction based at least in part that the list of items includes an item required for the redemption of the offer; and apply (283) a benefit of the offer to the payment transaction during authorization of the payment transaction.

In one embodiment, a gateway of a transaction handler of a payment processing network is configured to receive authorization requests from transaction terminals for transactions in payment accounts. The authorization requests are transmitted from the transaction terminals to the gateway without going through respective acquirer processors. The gateway is configured to determine whether offers in the accounts of the users are applicable to the transactions. The gateway, or a transaction handler, is configured to push the transactions to the acquirer processors, after processing the authorization request in view of the offers. Further details about the processing of the authorization request transmitted via the gateway can be found in U.S. Pat. App. Pub. No. 2013/0268333, the entire disclosure of which application is hereby incorporated herein by reference.

In one embodiment, a portal coupled to a transaction handler is configured to provide enhanced services related to the presentation of receipts, such as indication of offer benefits redeemed in the transaction. When an enhanced receipt service is available for a transaction approved via an authorization response transmitted to the acquirer processor and the transaction terminal, the authorization response is configured to indicate the availability of the enhanced receipt service. A transaction terminal that is configured to have the capability of communicating with the portal to present the enhanced receipt service can use the indication provided in the authorization response to initiate the communication for enhanced receipt services, and a conventional transaction terminal that lacks the same capability may ignore the indication provided in the authorization response. Thus, the system is compatible with conventional transaction terminals that lack such a capability, while still allowing the utilization of transaction terminals in the same network that supports such a capability and thus can provide enhanced services for users of the respective transaction terminals. Further details and examples about the enhanced receipt service can be found in U.S. Pat. App. Pub. No. 2013/0268333, the entire disclosure of which application is hereby incorporated herein by reference.

In one embodiment, in response to the transaction handler of one embodiment determining that a transaction in a payment account, as identified in an authorization request, received from an acquirer processor for the transaction, is eligible for the benefit of an offer associated with the payment account, the transaction handler split the transaction originally requested in the payment account into two or more transactions with an issuer processor of the payment account and one or more sponsor processors of the offer to apply the benefit of the offer to the authorization request for the transaction requested. The two or more transactions are combined for the transaction terminal of the merchant and/or the acquirer processor, such that the details of the two or more transactions are insulated from the transaction terminal and/or the acquirer processor. Thus, a conventional transaction terminal and/or a conventional acquirer processor can be used in the system configured to apply the benefit of an offer during the processing of a transaction initiated and completed at the transaction terminal. Further details and examples of splitting a transaction to apply offer benefits can be found in U.S. Pat. App. Pub. No. 2013/0246150, the entire disclosure of which application is hereby incorporated herein by reference.

To facilitate offer redemption via the split-transaction technique as identified above, data associating offers with account information identifying the consumer accounts or payment accounts of the users can be stored in a data warehouse coupled with the transaction handler. For example, in one embodiment of associating offers with consumer/payment accounts, a portal of the transaction handler is configured to store data representing offers, and to associate user selected offers with the financial accounts of the respective users, if the users select advertisements containing the offers. When the financial accounts are used to make payments processed by the transaction handler for purchases that satisfy the respective redemption conditions of the offers, the transaction handler and/or the portal are configured to detect such payment transactions and fulfill the offers in an automated way, such as in the embodiment of the split-transaction identified above.

For example, the advertisement providing the offer can be configured to have multiple selectable regions when the advertisement is presented in a web browser of a user. Examples of offers include discounts, incentives, rebates, coupons, rewards, cash back, etc. One of the selectable-regions contains a Uniform Resource Locator (URL) of the advertiser or merchant, which, when selected, directs the user to the website of the advertiser or merchant. A separate one of the selectable regions contains a Uniform Resource Locator (URL) of the portal of the transaction handler, which, when selected, directs the user to the portal for access to a user interface to register the offer with a financial account of the user. Examples of financial accounts of users include credit card accounts, debit card accounts, prepaid card accounts, bank accounts, etc. Further details and examples can be found in U.S. Pat. App. Pub. No. 2011/0125565, the entire disclosure of which application is hereby incorporated herein by reference.

After the offer is associated with the financial account of the user, the transaction handler and/or the portal are configured to detect that the user is making a payment using the financial account for a purchase that satisfies the redemption requirements of the offer. In response to the detection, the portal may optionally notify the user of the eligibility of the redemption of the offer using a communication reference associated with the financial account, and the transaction handler and/or the portal are configured to automate the processing of the offer for redemption, such as using the split-payment embodiment identified above, or via statement credits to the financial account of the user, or via benefits afforded via a loyalty program, such as reward points, loyalty points, etc. Further details and examples can be found in U.S. Pat. App. Pub. No. 2011/0125565, the entire disclosure of which application is hereby incorporated herein by reference.

When an offer is sponsored by the merchant, the transaction handler can be configured in one embodiment to apply the benefit of the registered offer during the authorization and/or settlement of the transaction that meets the requirement for the redemption of the offer via modifying the transaction amount. For example, the authorization amount can be changed by the transaction handler to provide the benefit of the registered offer during the authorization phase of the transaction in one embodiment, and the settlement amount can be changed by the transaction handler to provide the benefit of the registered offer during the settlement phase of the transaction in another embodiment. Some details and examples about redeeming offer benefits, sponsored by merchants, via modifying transaction amounts can be found in U.S. Pat. App. Pub. No. 2013/0124287, the entire disclosure of which application is hereby incorporated herein by reference.

The transaction data, such as records of transactions made via credit accounts, debit accounts, prepaid accounts, bank accounts, stored value accounts and the like, can be further processed to optionally provide information for various services, such as reporting, benchmarking, advertising, content or offer selection, customization, personalization, prioritization, etc. In one embodiment of improving privacy protections, users are required to enroll in a service program and provide consent to allow the system to use related transaction data and/or other data for the related services, and the system is configured to provide the services while protecting the privacy of the users in accordance with the enrollment agreement and user consent.

For example, based on the transaction data, an advertising network in one embodiment is provided to present personalized or targeted advertisements/offers on behalf of advertisers. A computing apparatus of, or associated with, the transaction handler uses the transaction data and/or other data, such as account data, merchant data, search data, social networking data, web data, etc., to develop intelligence information about individual customers, or certain types or groups of customers. The intelligence information can be used to select, identify, generate, adjust, prioritize, and/or personalize advertisements/offers to the customers. The transaction handler may be further automated to process the advertisement fees charged to the advertisers, using the accounts of the advertisers, in response to the advertising activities.

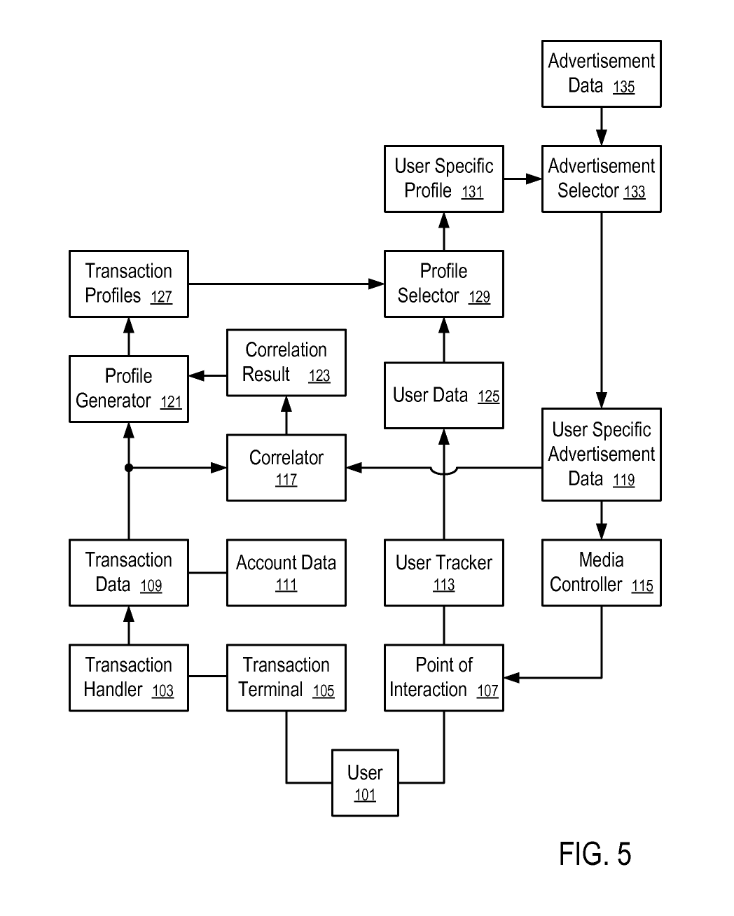

FIG. 5 illustrates a system to provide services based on transaction data according to one embodiment. In FIG. 5, the system includes a transaction terminal (105) to initiate financial transactions for a user (101), a transaction handler (103) to generate transaction data (109) from processing the financial transactions of the user (101) (and the financial transactions of other users), a profile generator (121) to generate transaction profiles (127) based on the transaction data (109) to provide information/intelligence about user preferences and spending patterns, a point of interaction (107) to provide information and/or offers to the user (101), a user tracker (113) to generate user data (125) to identify the user (101) using the point of interaction (107), a profile selector (129) to select a profile (131) specific to the user (101) identified by the user data (125), and an advertisement selector (133) to select, identify, generate, adjust, prioritize and/or personalize advertisements for presentation to the user (101) on the point of interaction (107) via a media controller (115).

In FIG. 5, the system further includes a correlator (117) to correlate user specific advertisement data (119) with transactions resulting from the user specific advertisement data (119). The correlation results (123) can be used by the profile generator (121) to improve the transaction profiles (127).

The transaction profiles (127) of one embodiment are generated from the transaction data (109) in a way as discussed in U.S. Pat. App. Pub. No. 2010/0306032, where an aggregated spending profile is generated via the factor analysis and cluster analysis to summarize the spending patterns/behaviors reflected in the transaction records (255).

In one embodiment, a data warehouse (149) as illustrated in FIG. 6 is coupled with the transaction handler (103) to store the transaction data (109) and other data, such as account data (111), transaction profiles (127) and correlation results (123). In FIG. 6, a portal (143) is coupled with the data warehouse (149) to provide data or information derived from the transaction data (109), in response to a query request from a third party or as an alert or notification message.

In FIG. 6, the transaction handler (103) is coupled between an issuer processor (145) in control of a consumer account (146) and an acquirer processor (147) in control of a merchant account (148). An account identification device (141) is configured to carry the account information (142) that identifies the consumer account (146) with the issuer processor (145) and provide the account information (142) to the transaction terminal (105) of a merchant to initiate a transaction between the user (101) and the merchant.

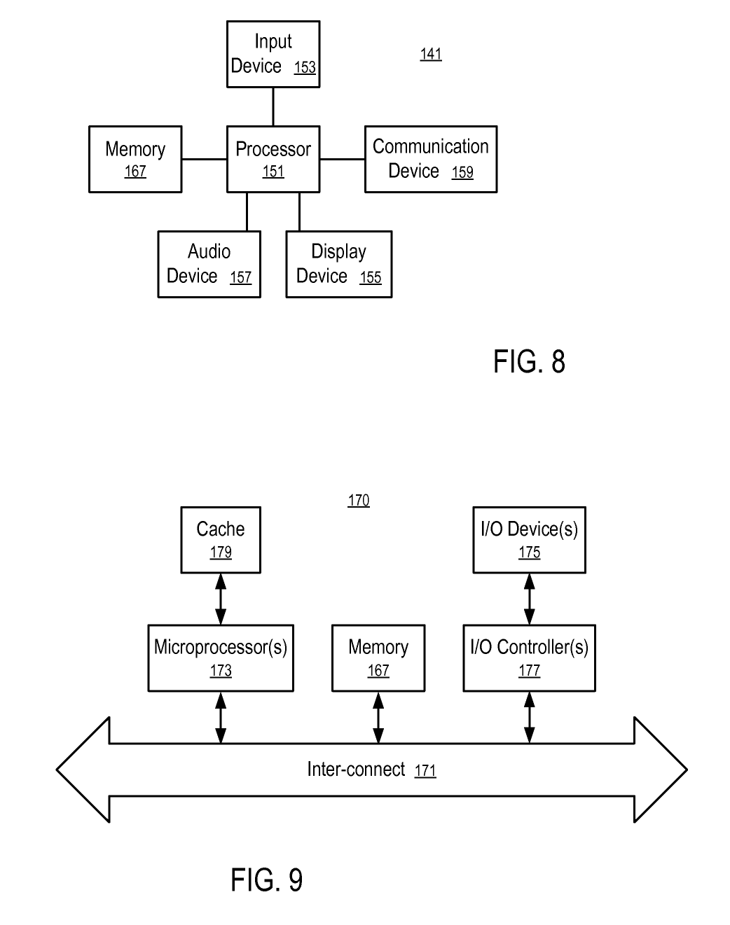

FIGS. 7 and 8 illustrate examples of transaction terminals (105) and account identification devices (141). FIG. 9 illustrates the structure of a data processing system (170) that can be used to implement, with more or fewer elements, at least some of the components in the system, such as the point of interaction (107), the transaction handler (103), the portal (143), the data warehouse, the account identification device (141), the transaction terminal (105), the user tracker (113), the profile generator (121), the profile selector (129), the advertisement selector (133), the media controller (115), etc. Some embodiments use more or fewer components than those illustrated.

In one embodiment, the transaction data (109) relates to financial transactions processed by the transaction handler (103); and the account data (111) relates to information about the account holders involved in the transactions. Further data, such as merchant data that relates to the location, business, products and/or services of the merchants that receive payments from account holders for their purchases, can be used in the generation of the transaction profiles (127).

In one embodiment, the financial transactions are made via an account identification device (141), such as financial transaction cards (e.g., credit cards, debit cards, banking cards, etc.); the financial transaction cards may be embodied in various devices, such as plastic cards, chips, radio frequency identification (RFID) devices, mobile phones, personal digital assistants (PDAs), etc.; and the financial transaction cards may be represented by account identifiers (e.g., account numbers or aliases). In one embodiment, the financial transactions are made via directly using the account information (142), without physically presenting the account identification device (141).

Further features, modifications and details are provided in various sections of this description.

In one embodiment, the transaction handler (103) couples with a centralized data warehouse (149) organized around the transaction data (109). For example, the centralized data warehouse (149) may include, and/or support the determination of, spend band distribution, transaction count and amount, merchant categories, merchant by state, cardholder segmentation by velocity scores, and spending within merchant target, competitive set and cross-section. For example, the centralized data warehouse (149) may include the advertisement data (135) and/or offers of benefits such as discount, reward, points, cashback, etc. The offers can be communicated to the users (e.g., 101) via the advertisement data (135) or as part of the advertisement data (135).

In one embodiment, the centralized data warehouse (149) provides centralized management but allows decentralized execution. For example, a third party strategic marketing analyst, statistician, marketer, promoter, business leader, etc., may access the centralized data warehouse (149) to analyze customer and shopper data, to provide follow-up analyses of customer contributions, to develop propensity models for increased conversion of marketing campaigns, to develop segmentation models for marketing, etc. The centralized data warehouse (149) can be used to manage advertisement campaigns and analyze response profitability.

In one embodiment, the centralized data warehouse (149) includes merchant data (e.g., data about sellers), customer/business data (e.g., data about buyers), and transaction records (255) between sellers and buyers over time. The centralized data warehouse (149) can be used to support corporate sales forecasting, fraud analysis reporting, sales/customer relationship management (CRM) business intelligence, credit risk prediction and analysis, advanced authorization reporting, merchant benchmarking, business intelligence for small business, rewards, etc.

In one embodiment, the transaction data (109) is combined with external data, such as surveys, benchmarks, search engine statistics, demographics, competition information, emails, etc., to flag key events and data values, to set customer, merchant, data or event triggers, and to drive new transactions and new customer contacts.

In FIG. 5, the profile generator (121) generates transaction profiles (127) based on the transaction data (109), the account data (111), and/or other data, such as non-transactional data, wish lists, merchant provided information, address information, information from social network websites, information from credit bureaus, information from search engines, and other examples discussed in U.S. Pat. App. Pub. No. 2011/0054981, entitled “Analyzing Local Non-Transactional Data with Transactional Data in Predictive Models,” the disclosure of which is hereby incorporated herein by reference.

In one embodiment, the transaction profiles (127) provide intelligence information on the behavior, pattern, preference, propensity, tendency, frequency, trend, and budget of the user (101) in making purchases. In one embodiment, the transaction profiles (127) include information about what the user (101) owns, such as points, miles, or other rewards currency, available credit, and received offers, such as coupons loaded into the accounts of the user (101). In one embodiment, the transaction profiles (127) include information based on past offer/coupon redemption patterns. In one embodiment, the transaction profiles (127) include information on shopping patterns in retail stores as well as online, including frequency of shopping, amount spent in each shopping trip, distance of merchant location (retail) from the address of the account holder(s), etc.

In one embodiment, the transaction handler (103) (and/or the portal (143)) is configured to provide at least part of the intelligence for the prioritization, generation, selection, customization and/or adjustment of the advertisement for delivery within a transaction process involving the transaction handler (103). For example, the advertisement may be presented to a customer in response to the customer making a payment via the transaction handler (103).

Some of the transaction profiles (127) are specific to the user (101), or to an account of the user (101), or to a group of users of which the user (101) is a member, such as a household, family, company, neighborhood, city, or group identified by certain characteristics related to online activities, offline purchase activities, merchant propensity, etc.

The profile generator (121) may generate and update the transaction profiles (127) in batch mode periodically, or generates the transaction profiles (127) in real time, or just in time, in response to a request received in the portal (143) for such profiles.

The transaction profiles (127) of one embodiment include the values for a set of parameters. Computing the values of the parameters may involve counting transactions that meet one or more criteria, and/or building a statistically-based model in which one or more calculated values or transformed values are put into a statistical algorithm that weights each value to optimize its collective predictiveness for various predetermined purposes.

Details about aggregated spending profile in one embodiment are provided in U.S. Pat. App. Pub. No. 2010/0306032, entitled “Systems and Methods to Summarize Transaction Data,” the disclosure of which is hereby incorporated herein by reference.

In one embodiment, a set of profiles are generated from the transaction data for a plurality of geographical regions, such as mutually exclusive, non-overlapping regions defined by postal codes. Transactions of account holders residing in the regions are aggregated according to merchant categories for the respective regions and subsequently normalized to obtain preference indicators that reveal the spending preferences of the account holders in the respective regions. Each of the profiles for respective regions is based on a plurality of different account holders and/or households to avoid revealing private information about individual account holders or families. Further, the profiles are constructed in a way to make it impossible to reverse calculate the transaction amounts. Further details and examples about profiles constructed for regions in one embodiment are provided in U.S. Pat. App. Pub. No. 2013/0124263, entitled “Systems and Methods to Summarize Transaction data,” the disclosure of which is hereby incorporated herein by reference.

In one embodiment, the transaction handler (103) is configured to selectively request purchase details via authorization responses. When the transaction handler (103) (and/or the issuer processor (145)) needs purchase details, such as identification of specific items purchased and/or their prices, the authorization responses transmitted from the transaction handler (103) is to include an indicator to request for the purchase details for the transaction that is being authorized. The merchants are to determine whether or not to submit purchase details based on whether or not there is a demand indicated in the authorization responses from the transaction handler (103). Further details and examples of obtaining purchase details via a request provided in the authorization response can be found in U.S. Pat. App. Pub. No. 2011/0093335, the entire disclosure of which application is hereby incorporated herein by reference.

### Transaction Processing

FIG. 6 shows a system to provide information and/or services based on transaction data (109) according to one embodiment.

In FIG. 6, the transaction handler (103) is coupled between an issuer processor (145) and an acquirer processor (147) to facilitate authorization and settlement of transactions between a consumer account (146) and a merchant account (148). The transaction handler (103) records the transactions in the data warehouse (149). The portal (143) is coupled to the data warehouse (149) to provide information based on the transaction records (255), such as the transaction profiles (127), aggregated spending profile, offer redemption notification, etc. The portal (143) may be implemented as a web portal, a telephone gateway, a file/data server, etc.

In FIG. 6, the transaction terminal (105) initiates the transaction for a user (101) (e.g., a customer) for processing by a transaction handler (103). The transaction handler (103) processes the transaction and stores transaction data (109) about the transaction, in connection with account data (111), such as the account profile of an account of the user (101). The account data (111) may further include data about the user (101), collected from issuers or merchants, and/or other sources, such as social networks, credit bureaus, merchant provided information, address information, etc. In one embodiment, a transaction may be initiated by a server (e.g., based on a stored schedule for recurrent payments).

The accumulated transaction data (109) and the corresponding account data (111) are used to generate intelligence information about the purchase behavior, pattern, preference, tendency, frequency, trend, amount and/or propensity of the users (e.g., 101), as individuals or as a member of a group. The intelligence information can then be used to generate, identify and/or select targeted advertisements for presentation to the user (101) on the point of interaction (107), during a transaction, after a transaction, or when other opportunities arise.

In FIG. 6, the consumer account (146) is under the control of the issuer processor (145). The consumer account (146) may be owned by an individual, or an organization such as a business, a school, etc. The consumer account (146) may be a credit account, a debit account, or a stored value account. The issuer may provide the consumer (e.g., user (101)) an account identification device (141) to identify the consumer account (146) using the account information (142). The respective consumer of the account (146) can be called an account holder or a cardholder, even when the consumer is not physically issued a card, or the account identification device (141), in one embodiment. The issuer processor (145) is to charge the consumer account (146) to pay for purchases.

The account identification device (141) of one embodiment is a plastic card having a magnetic strip storing account information (142) identifying the consumer account (146) and/or the issuer processor (145). Alternatively, the account identification device (141) is a smartcard having an integrated circuit chip storing at least the account information (142). The account identification device (141) may optionally include a mobile phone having an integrated smartcard.

The account information (142) may be printed or embossed on the account identification device (141). The account information (142) may be printed as a bar code to allow the transaction terminal (105) to read the information via an optical scanner. The account information (142) may be stored in a memory of the account identification device (141) and configured to be read via wireless, contactless communications, such as near field communications via magnetic field coupling, infrared communications, or radio frequency communications. Alternatively, the transaction terminal (105) may require contact with the account identification device (141) to read the account information (142) (e.g., by reading the magnetic strip of a card with a magnetic strip reader).

The transaction terminal (105) is configured to transmit an authorization request message to the acquirer processor (147). The authorization request includes the account information (142), an amount of payment, and information about the merchant (e.g., an indication of the merchant account (148)). The acquirer processor (147) requests the transaction handler (103) to process the authorization request, based on the account information (142) received in the transaction terminal (105). The transaction handler (103) routes the authorization request to the issuer processor (145) and may process and respond to the authorization request when the issuer processor (145) is not available. The issuer processor (145) determines whether to authorize the transaction based at least in part on a balance of the consumer account (146).

The transaction handler (103), the issuer processor (145), and the acquirer processor (147) may each include a subsystem to identify the risk in the transaction and may reject the transaction based on the risk assessment.

The account identification device (141) may include security features to prevent unauthorized uses of the consumer account (146), such as a logo to show the authenticity of the account identification device (141), encryption to protect the account information (142), etc.

The transaction terminal (105) of one embodiment is configured to interact with the account identification device (141) to obtain the account information (142) that identifies the consumer account (146) and/or the issuer processor (145). The transaction terminal (105) communicates with the acquirer processor (147) that controls the merchant account (148) of a merchant. The transaction terminal (105) may communicate with the acquirer processor (147) via a data communication connection, such as a telephone connection, an Internet connection, etc. The acquirer processor (147) is to collect payments into the merchant account (148) on behalf of the merchant.

In one embodiment, the transaction terminal (105) is a POS terminal at a traditional, offline, “brick and mortar” retail store. In another embodiment, the transaction terminal (105) is an online server that receives account information (142) of the consumer account (146) from the user (101) through a web connection. In one embodiment, the user (101) may provide account information (142) through a telephone call, via verbal communications with a representative of the merchant; and the representative enters the account information (142) into the transaction terminal (105) to initiate the transaction.

In one embodiment, the account information (142) can be entered directly into the transaction terminal (105) to make payment from the consumer account (146), without having to physically present the account identification device (141). When a transaction is initiated without physically presenting an account identification device (141), the transaction is classified as a “card-not-present” (CNP) transaction.

In general, the issuer processor (145) may control more than one consumer account (146); the acquirer processor (147) may control more than one merchant account (148); and the transaction handler (103) is connected between a plurality of issuer processors (e.g., 145) and a plurality of acquirer processors (e.g., 147). An entity (e.g., bank) may operate both an issuer processor (145) and an acquirer processor (147).

In one embodiment, the transaction handler (103), the issuer processor (145), the acquirer processor (147), the transaction terminal (105), the portal (143), and other devices and/or services accessing the portal (143) are connected via communications networks, such as local area networks, cellular telecommunications networks, wireless wide area networks, wireless local area networks, an intranet, and Internet. Dedicated communication channels may be used between the transaction handler (103) and the issuer processor (145), between the transaction handler (103) and the acquirer processor (147), and/or between the portal (143) and the transaction handler (103).

In FIG. 6, the transaction handler (103) uses the data warehouse (149) to store the records about the transactions, such as the transaction records (255) or transaction data (109).

Typically, the transaction handler (103) is implemented using a powerful computer, or cluster of computers functioning as a unit, controlled by instructions stored on a computer readable medium. The transaction handler (103) is configured to support and deliver authorization services, exception file services, and clearing and settlement services. The transaction handler (103) has a subsystem to process authorization requests and another subsystem to perform clearing and settlement services. The transaction handler (103) is configured to process different types of transactions, such credit card transactions, debit card transactions, prepaid card transactions, and other types of commercial transactions. The transaction handler (103) interconnects the issuer processors (e.g., 145) and the acquirer processor (e.g., 147) to facilitate payment communications.

In FIG. 6, the transaction terminal (105) is configured to submit the authorized transactions to the acquirer processor (147) for settlement. The amount for the settlement may be different from the amount specified in the authorization request. The transaction handler (103) is coupled between the issuer processor (145) and the acquirer processor (147) to facilitate the clearing and settling of the transaction. Clearing includes the exchange of financial information between the issuer processor (145) and the acquirer processor (147); and settlement includes the exchange of funds.

In FIG. 6, the issuer processor (145) is configured to provide funds to make payments on behalf of the consumer account (146). The acquirer processor (147) is to receive the funds on behalf of the merchant account (148). The issuer processor (145) and the acquirer processor (147) communicate with the transaction handler (103) to coordinate the transfer of funds for the transaction. The funds can be transferred electronically.

The transaction terminal (105) may submit a transaction directly for settlement, without having to separately submit an authorization request.

In one embodiment, the portal (143) provides a user interface to allow the user (101) to organize the transactions in one or more consumer accounts (146) of the user with one or more issuers. The user (101) may organize the transactions using information and/or categories identified in the transaction records (255), such as merchant category, transaction date, amount, etc. Examples and techniques in one embodiment are provided in U.S. Pat. App. Pub. No. 2007/0055597, entitled “Method and System for Manipulating Purchase Information,” the disclosure of which is hereby incorporated herein by reference.

In one embodiment, the portal (143) provides transaction based statistics, such as indicators for retail spending monitoring, indicators for merchant benchmarking, industry/market segmentation, indicators of spending patterns, etc. Further examples can be found in U.S. Pat. App. Pub. No. 2009/0048884, entitled “Merchant Benchmarking Tool,” the disclosure of which application is hereby incorporated herein by reference.

### Transaction Terminal

FIG. 7 illustrates a transaction terminal according to one embodiment. The transaction terminal (105) illustrated in FIG. 7 can be used in various systems discussed in connection with other figures of the present disclosure. In FIG. 7, the transaction terminal (105) is configured to interact with an account identification device (141) to obtain account information (142) about the consumer account (146).

In one embodiment, the transaction terminal (105) includes a memory (167) coupled to the processor (151), which controls the operations of a reader (163), an input device (153), an output device (165) and a network interface (161). The memory (167) may store instructions for the processor (151) and/or data, such as an identification that is associated with the merchant account (148).

In one embodiment, the reader (163) includes a magnetic strip reader. In another embodiment, the reader (163) includes a contactless reader, such as a radio frequency identification (RFID) reader, a near field communications (NFC) device configured to read data via magnetic field coupling (in accordance with ISO standard 14443/NFC), a Bluetooth transceiver, a WiFi transceiver, an infrared transceiver, a laser scanner, etc.

In one embodiment, the input device (153) includes key buttons that can be used to enter the account information (142) directly into the transaction terminal (105) without the physical presence of the account identification device (141). The input device (153) can be configured to provide further information to initiate a transaction, such as a personal identification number (PIN), password, zip code, etc. that may be used to access the account identification device (141), or in combination with the account information (142) obtained from the account identification device (141).

In one embodiment, the output device (165) may include a display, a speaker, and/or a printer to present information, such as the result of an authorization request, a receipt for the transaction, an advertisement, etc.

In one embodiment, the network interface (161) is configured to communicate with the acquirer processor (147) via a telephone connection, an Internet connection, or a dedicated data communication channel.

In one embodiment, the instructions stored in the memory (167) are configured at least to cause the transaction terminal (105) to send an authorization request message to the acquirer processor (147) to initiate a transaction. The transaction terminal (105) may or may not send a separate request for the clearing and settling of the transaction. The instructions stored in the memory (167) are also configured to cause the transaction terminal (105) to perform other types of functions discussed in this description.

In one embodiment, a transaction terminal (105) may have fewer components than those illustrated in FIG. 7. For example, in one embodiment, the transaction terminal (105) is configured for “card-not-present” transactions; and the transaction terminal (105) does not have a reader (163).

In one embodiment, a transaction terminal (105) may have more components than those illustrated in FIG. 7. For example, in one embodiment, the transaction terminal (105) is an ATM machine, which includes components to dispense cash under certain conditions.

### Account Identification Device

FIG. 8 illustrates an account identifying device according to one embodiment. In FIG. 8, the account identification device (141) is configured to carry account information (142) that identifies the consumer account (146).

In one embodiment, the account identification device (141) includes a memory (167) coupled to the processor (151), which controls the operations of a communication device (159), an input device (153), an audio device (157) and a display device (155). The memory (167) may store instructions for the processor (151) and/or data, such as the account information (142) associated with the consumer account (146).

In one embodiment, the account information (142) includes an identifier identifying the issuer (and thus the issuer processor (145)) among a plurality of issuers, and an identifier identifying the consumer account among a plurality of consumer accounts controlled by the issuer processor (145). The account information (142) may include an expiration date of the account identification device (141), the name of the consumer holding the consumer account (146), and/or an identifier identifying the account identification device (141) among a plurality of account identification devices associated with the consumer account (146).

In one embodiment, the account information (142) may further include a loyalty program account number, accumulated rewards of the consumer in the loyalty program, an address of the consumer, a balance of the consumer account (146), transit information (e.g., a subway or train pass), access information (e.g., access badges), and/or consumer information (e.g., name, date of birth), etc.

In one embodiment, the memory includes a nonvolatile memory, such as magnetic strip, a memory chip, a flash memory, a Read Only Memory (ROM), etc. to store the account information (142).

In one embodiment, the information stored in the memory (167) of the account identification device (141) may also be in the form of data tracks that are traditionally associated with credits cards. Such tracks include Track 1 and Track 2. Track 1 (“International Air Transport Association”) stores more information than Track 2, and contains the cardholder's name as well as the account number and other discretionary data. Track 1 is sometimes used by airlines when securing reservations with a credit card. Track 2 (“American Banking Association”) is currently most commonly used and is read by ATMs and credit card checkers. The ABA (American Banking Association) designed the specifications of Track 1 and banks abide by it. It contains the cardholder's account number, encrypted PIN, and other discretionary data.

In one embodiment, the communication device (159) includes a semiconductor chip to implement a transceiver for communication with the reader (163) and an antenna to provide and/or receive wireless signals.

In one embodiment, the communication device (159) is configured to communicate with the reader (163). The communication device (159) may include a transmitter to transmit the account information (142) via wireless transmissions, such as radio frequency signals, magnetic coupling, or infrared, Bluetooth or WiFi signals, etc.

In one embodiment, the account identification device (141) is in the form of a mobile phone, personal digital assistant (PDA), etc. The input device (153) can be used to provide input to the processor (151) to control the operation of the account identification device (141); and the audio device (157) and the display device (155) may present status information and/or other information, such as advertisements or offers. The account identification device (141) may include further components that are not shown in FIG. 8, such as a cellular communications subsystem.

In one embodiment, the communication device (159) may access the account information (142) stored on the memory (167) without going through the processor (151).

In one embodiment, the account identification device (141) has fewer components than those illustrated in FIG. 8. For example, an account identification device (141) does not have the input device (153), the audio device (157) and the display device (155) in one embodiment; and in another embodiment, an account identification device (141) does not have components (151-159).

For example, in one embodiment, an account identification device (141) is in the form of a debit card, a credit card, a smartcard, or a consumer device that has optional features such as magnetic strips, or smartcards.

An example of an account identification device (141) is a magnetic strip attached to a plastic substrate in the form of a card. The magnetic strip is used as the memory (167) of the account identification device (141) to provide the account information (142). Consumer information, such as account number, expiration date, and consumer name may be printed or embossed on the card. A semiconductor chip implementing the memory (167) and the communication device (159) may also be embedded in the plastic card to provide account information (142) in one embodiment. In one embodiment, the account identification device (141) has the semiconductor chip but not the magnetic strip.

In one embodiment, the account identification device (141) is integrated with a security device, such as an access card, a radio frequency identification (RFID) tag, a security card, a transponder, etc.

In one embodiment, the account identification device (141) is a handheld and compact device. In one embodiment, the account identification device (141) has a size suitable to be placed in a wallet or pocket of the consumer.

Some examples of an account identification device (141) include a credit card, a debit card, a stored value device, a payment card, a gift card, a smartcard, a smart media card, a payroll card, a health care card, a wrist band, a keychain device, a supermarket discount card, a transponder, and a machine readable medium containing account information (142).

### Point of Interaction

In one embodiment, the point of interaction (107) is to provide an advertisement to the user (101), or to provide information derived from the transaction data (109) to the user (101).

In one embodiment, an advertisement is a marketing interaction which may include an announcement and/or an offer of a benefit, such as a discount, incentive, reward, coupon, gift, cash back, or opportunity (e.g., special ticket/admission). An advertisement may include an offer of a product or service, an announcement of a product or service, or a presentation of a brand of products or services, or a notice of events, facts, opinions, etc. The advertisements can be presented in text, graphics, audio, video, or animation, and as printed matter, web content, interactive media, etc. An advertisement may be presented in response to the presence of a financial transaction card, or in response to a financial transaction card being used to make a financial transaction, or in response to other user activities, such as browsing a web page, submitting a search request, communicating online, entering a wireless communication zone, etc. In one embodiment, the presentation of advertisements may be not a result of a user action.

In one embodiment, the point of interaction (107) can be one of various endpoints of the transaction network, such as point of sale (POS) terminals, automated teller machines (ATMs), electronic kiosks (or computer kiosks or interactive kiosks), self-assist checkout terminals, vending machines, gas pumps, websites of banks (e.g., issuer banks or acquirer banks of credit cards), bank statements (e.g., credit card statements), websites of the transaction handler (103), websites of merchants, checkout websites or web pages for online purchases, etc.

In one embodiment, the point of interaction (107) may be the same as the transaction terminal (105), such as a point of sale (POS) terminal, an automated teller machine (ATM), a mobile phone, a computer of the user for an online transaction, etc. In one embodiment, the point of interaction (107) may be co-located with, or near, the transaction terminal (105) (e.g., a video monitor or display, a digital sign), or produced by the transaction terminal (e.g., a receipt produced by the transaction terminal (105)). In one embodiment, the point of interaction (107) may be separate from and not co-located with the transaction terminal (105), such as a mobile phone, a personal digital assistant, a personal computer of the user, a voice mail box of the user, an email inbox of the user, a digital sign, etc.

For example, the advertisements can be presented on a portion of media for a transaction with the customer, which portion might otherwise be unused and thus referred to as a “white space” herein. A white space can be on a printed matter (e.g., a receipt printed for the transaction, or a printed credit card statement), on a video display (e.g., a display monitor of a POS terminal for a retail transaction, an ATM for cash withdrawal or money transfer, a personal computer of the customer for online purchases), or on an audio channel (e.g., an interactive voice response (IVR) system for a transaction over a telephonic device).

In one embodiment, the white space is part of a media channel available to present a message from the transaction handler (103) in connection with the processing of a transaction of the user (101). In one embodiment, the white space is in a media channel that is used to report information about a transaction of the user (101), such as an authorization status, a confirmation message, a verification message, a user interface to verify a password for the online use of the account information (142), a monthly statement, an alert or a report, or a web page provided by the portal (143) to access a loyalty program associated with the consumer account (146) or a registration program.

In other embodiments, the advertisements can also be presented via other media channels which may not involve a transaction processed by the transaction handler (103). For example, the advertisements can be presented on publications or announcements (e.g., newspapers, magazines, books, directories, radio broadcasts, television, digital signage, etc., which may be in an electronic form, or in a printed or painted form). The advertisements may be presented on paper, on websites, on billboards, on digital signs, or on audio portals.

In one embodiment, the transaction handler (103) purchases the rights to use the media channels from the owner or operators of the media channels and uses the media channels as advertisement spaces. For example, white spaces at a point of interaction (e.g., 107) with customers for transactions processed by the transaction handler (103) can be used to deliver advertisements relevant to the customers conducting the transactions; and the advertisement can be selected based at least in part on the intelligence information derived from the accumulated transaction data (109) and/or the context at the point of interaction (107) and/or the transaction terminal (105).

In general, a point of interaction (e.g., 107) may or may not be capable of receiving inputs from the customers, and may or may not co-located with a transaction terminal (e.g., 105) that initiates the transactions. The white spaces for presenting the advertisement on the point of interaction (107) may be on a portion of a geographical display space (e.g., on a screen), or on a temporal space (e.g., in an audio stream).

In one embodiment, the point of interaction (107) may be used to primarily to access services not provided by the transaction handler (103), such as services provided by a search engine, a social networking website, an online marketplace, a blog, a news site, a television program provider, a radio station, a satellite, a publisher, etc.

In one embodiment, a consumer device is used as the point of interaction (107), which may be a non-portable consumer device or a portable computing device. The consumer device is to provide media content to the user (101) and may receive input from the user (101).

Examples of non-portable consumer devices include a computer terminal, a television set, a personal computer, a set-top box, or the like. Examples of portable consumer devices include a portable computer, a cellular phone, a personal digital assistant (PDA), a pager, a security card, a wireless terminal, or the like. The consumer device may be implemented as a data processing system as illustrated in FIG. 9, with more or fewer components.

In one embodiment, the consumer device includes an account identification device (141). For example, a smart card used as an account identification device (141) is integrated with a mobile phone, or a personal digital assistant (PDA).

In one embodiment, the point of interaction (107) is integrated with a transaction terminal (105). For example, a self-service checkout terminal includes a touch pad to interact with the user (101); and an ATM machine includes a user interface subsystem to interact with the user (101).

### Data Processing System

In one embodiment, a computing apparatus is configured to include some of the computer systems illustrated in various figures. At least some of the computer systems, such as the transaction handler (103), the transaction terminal (105), the point of interaction (107), the portal (143), the issuer processor (145), the acquirer processor (147), and the account identification device (141), can be implemented as a data processing system (170) illustrated in FIG. 9. Some of the components may share hardware or be combined on a computer system. In one embodiment, a network of computers can be used to implement one or more of the components.

FIG. 9 illustrates a data processing system according to one embodiment. While FIG. 9 illustrates various components of a computer system, it is not intended to represent any particular architecture or manner of interconnecting the components. One embodiment may use other systems that have fewer or more components than those shown in FIG. 9.

In FIG. 9, the data processing system (170) includes an inter-connect (171) (e.g., bus and system core logic), which interconnects a microprocessor(s) (173) and memory (167). The microprocessor (173) is coupled to cache memory (179) in the example of FIG. 9.

In one embodiment, the inter-connect (171) interconnects the microprocessor(s) (173) and the memory (167) together and also interconnects them to input/output (I/O) device(s) (175) via I/O controller(s) (177). I/O devices (175) may include a display device and/or peripheral devices, such as mice, keyboards, modems, network interfaces, printers, scanners, video cameras and other devices known in the art. In one embodiment, when the data processing system is a server system, some of the I/O devices (175), such as printers, scanners, mice, and/or keyboards, are optional.

In one embodiment, the inter-connect (171) includes one or more buses connected to one another through various bridges, controllers and/or adapters. In one embodiment the I/O controllers (177) include a USB (Universal Serial Bus) adapter for controlling USB peripherals, and/or an IEEE-1394 bus adapter for controlling IEEE-1394 peripherals.

In one embodiment, the memory (167) includes one or more of: ROM (Read Only Memory), volatile RAM (Random Access Memory), and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In this description, some functions and operations are described as being performed by or caused by software code to simplify description. However, such expressions are also used to specify that the functions result from execution of the code/instructions by a processor, such as a microprocessor.

Alternatively, or in combination, the functions and operations as described here can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While one embodiment can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions referred to as “computer programs.” The computer programs typically include one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others. The computer-readable media may store the instructions.

The instructions may also be embodied in digital and analog communication links for electrical, optical, acoustical or other forms of propagated signals, such as carrier waves, infrared signals, digital signals, etc. However, propagated signals, such as carrier waves, infrared signals, digital signals, etc. are not tangible machine readable medium and are not configured to store instructions.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

### Other Aspects

The description and drawings are illustrative and are not to be construed as limiting. The present disclosure is illustrative of inventive features to enable a person skilled in the art to make and use the techniques. Various features, as described herein, should be used in compliance with all current and future rules, laws and regulations related to privacy, security, permission, consent, authorization, and others. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

The use of headings herein is merely provided for ease of reference, and shall not be interpreted in any way to limit this disclosure or the following claims.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, and are not necessarily all referring to separate or alternative embodiments mutually exclusive of other embodiments. Moreover, various features are described which may be exhibited by one embodiment and not by others. Similarly, various requirements are described which may be requirements for one embodiment but not other embodiments. Unless excluded by explicit description and/or apparent incompatibility, any combination of various features described in this description is also included here. For example, the features described above in connection with “in one embodiment” or “in some embodiments” can be all optionally included in one implementation, except where the dependency of certain features on other features, as apparent from the description, may limit the options of excluding selected features from the implementation, and incompatibility of certain features with other features, as apparent from the description, may limit the options of including selected features together in the implementation.

The disclosures of the above discussed patent documents are hereby incorporated herein by reference.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A computing apparatus, comprising:
a processing system connected in a first network of computers having a predetermined communication protocol for communication among at least the processing systems, terminals, and resource controllers in the first network;
a portal connected to a second network and providing an application programming interface for communication with the terminals independent from the predetermined communication protocol; and
a data store coupled with the processing system and the portal;
wherein the portal is configured to receive, from a terminal via the application programming interface, context data via the second network;
wherein the processing system is configured to receive, from the terminal, transaction data transmitted in the first network according to the predetermined communication protocol, the transaction data identifying a resource for processing a first predetermined operation in the first network, the resource controlled by a resource controller connected in the first network;
wherein the computing apparatus is configured to identify a second predetermined operation based at least in part on the resource identified in the transaction data and correlate, via the data store, the context data with the transaction data; and
wherein the transaction handler is configured to process the second predetermined operation, based on a combination of the context data and the transaction data, in addition to the first predetermined operation in the first network.

2. The computing apparatus of claim 1, wherein the data store is configured to store the context data in association with an correlation reference generated by the terminal.

3. The computing apparatus of claim 2, wherein the correlation reference is a hash value obtained by applying a hash function to at least a portion of the transaction data.

4. The computing apparatus of claim 2, wherein the correlation reference is an encrypted version of one or more selected fields of the transaction data.

5. A method, comprising:
providing a computing apparatus having:
a processing system connected in a first network of computers having a predetermined communication protocol for communication among at least the processing systems, terminals, and resource controllers in the first network;
a portal connected to a second network and providing an application programming interface for communication with the terminals independent from the predetermined communication protocol; and
a data store coupled with the processing system and the portal;
receiving, in the portal from a terminal via the application programming interface, context data via the second network;
receiving, in the processing system from the terminal, transaction data transmitted in the first network according to the predetermined communication protocol, the transaction data identifying a resource for processing a first predetermined operation in the first network, the resource controlled by a resource controller connected in the first network;
identifying a second predetermined operation based at least in part on the resource identified in the transaction data;
correlating, via the data store, the context data with the transaction data; and
processing, by the transaction handler, the second predetermined operation, based on a combination of the context data and the transaction data, in addition to the first predetermined operation in the first network.

6. The method of claim 5, further comprising:
storing, in the data store, the context data with an correlation reference.

7. The method of claim 6, wherein the correlation reference is a random number generated by the terminal.

8. The method of claim 6, wherein the correlation reference is a hash value obtained by applying a hash function to at least a portion of the transaction data.

9. The method of claim 6, wherein the correlation reference is an encrypted version of one or more selected fields of the transaction data.

10. The method of claim 6, wherein the transaction data transmitted in the first network according to the predetermined communication protocol includes the correlation reference.

11. The method of claim 10, wherein the terminal transmits the context data to the portal via the second network concurrently with transmission of the transaction data in the first network.

12. The method of claim 10, wherein the first network includes an electronic payment processing network; the terminal includes a point of sales terminal; and the processing system includes a transaction handler configured in the electronic payment processing network.

13. The method of claim 12, wherein the second network is via the Internet.

14. The method of claim 12, wherein the resource includes a payment account in the electronic payment processing network.

15. The method of claim 14, wherein the transaction data includes an authorization request for a transaction in the payment account.

16. The method of claim 15, wherein the context data includes purchase details identifying items purchased via the transaction.

17. The method of claim 16, wherein the data store further stores an offer in association with an identification of the payment account; the first predetermined operation includes authorization processing for the transaction in the electronic payment processing network; and the second predetermined operation includes redemption of a benefit of the offer.

18. The method of claim 17, further comprising:
determine applicability of the offer to the transaction based on identification of the items specified in the context data.

19. The method of claim 18, further comprising:
providing, by the transaction handler, the benefit of the offer to the transaction during the authorization processing of the transaction, in response to a determination that the identification of the items indicates that the offer is applicable to the transaction.

20. A non-transitory computer storage medium storing instructions configured to instruct a computing apparatus to perform a method, the method comprising:
providing, on a second network, the computing apparatus having:
a portal connected to the second network and providing an application programming interface for communication with terminals independent from a predetermined communication protocol for a first network of computers;
a processing system connected in the first network of computers having the predetermined communication protocol for communication among at least the processing systems, terminals, and resource controllers in the first network; and
a data store coupled with the processing system and the portal;
receiving, in the portal from a terminal via the application programming interface, context data via the second network;
receiving, in the processing system from the terminal, transaction data transmitted in the first network according to the predetermined communication protocol, the transaction data identifying a resource for processing a first predetermined operation in the first network, the resource controlled by a resource controller connected in the first network;
identifying a second predetermined operation based at least in part on the resource identified in the transaction data;
correlating, via the data store, the context data with the transaction data; and
processing, by the transaction handler, the second predetermined operation, based on a combination of the context data and the transaction data, in addition to the first predetermined operation in the first network.
